(19) United States
(12) Patent Application Publication
(10) Pub. No.: US 2013/0235784 A1
(43) Pub. Date: Sep. 12, 2013

(54) METHOD AND APPARATUS FOR MANAGING MULTICAST RESOURCE

(71) Applicant: ELECTRONICS AND TELECOMMUNICATIONS RESEARCH INSTITUTE, (US)

(72) Inventors: Eunkyung Kim, Daejeon (KR); Sung Kyung Kim, Daejeon (KR); Won-Ik Kim, Daejeon (KR); Sung Cheol Chang, Daejeon (KR); Seokki Kim, Gyeonggi-do (KR); Mi Young Yun, Daejeon (KR); Hyun Lee, Daejeon (KR); Chul Sik Yoon, Seoul (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/786,436

(22) Filed: Mar. 5, 2013

(30) Foreign Application Priority Data
Mar. 6, 2012 (KR) 10-2012-0022939
Mar. 5, 2013 (KR) 10-2013-0023128

(51) Int. Cl. H04W 72/00

(52) U.S. Cl. CPC H04W 72/005
USPC 370/312

(57) ABSTRACT

A method of managing a multicast resource is provided by a base station. The base station allocates a multicast resource to a multicast group. The base station generates a MAP IE including information of the multicast resource and a transmission indication for indicating whether the multicast resource is fragmented, and transmits the MAP IE to the multicast group.

### CROSS-REFERENCE TO RELATED APPLICATION

This application claims priority to and the benefit of Korean Patent Application Nos. 10-2012-0022939 and 10-2013-0023128 filed in the Korean Intellectual Property Office on Mar. 6, 2012 and Mar. 5, 2013, respectively, the entire contents of which are incorporated herein by reference.

### BACKGROUND OF THE INVENTION

(a) Field of the Invention

The present invention generally relates to a method and an apparatus for managing a multicast resource.

(b) Description of the Related Art

A multicast communication is used to a group communication where the same service is provided to a plurality of users at the same time. In the group communication, the same downlink traffic is simultaneously transmitted to all the users in a group for the group communication. Therefore, the users joining the group communication use a multicast connection to transmit data of the group communication.

A robust modulation and coding scheme (MCS) can be used to provide a reliable service regardless of positions of users receiving the multicast service. However, although the robust MCS can efficiently provide the multicast service to many users, it has restrictions for providing the multicast service by limited resource.

### SUMMARY OF THE INVENTION

An embodiment of the present invention provides a multicast resource management method and apparatus for efficiently providing a limited resource to a plurality of users.

According to another embodiment of the present invention, a method of managing a multicast resource is provided by a base station. The method includes allocating a multicast resource to a multicast group, generating a MAP information element (MAP IE) including information of the multicast resource and a transmission indication for indicating whether the multicast resource is fragmented, and transmitting the MAP IE to the multicast group.

When the multicast traffic is fragmented, the transmission indication may indicate which of fragmented traffics is transmitted by the multicast resource.

A first value of the transmission indication may indicate that no fragmented traffic is transmitted, a second value of the transmission indication may indicate that the first fragmented traffic is transmitted from among fragmented traffics, a third value of the transmission indication may indicate that the second to second last fragmented traffic are transmitted from among the fragmented traffics, and a fourth value of the transmission indication may indicate that the last fragmented traffic is transmitted from among the fragmented traffics.

The MAP IE may further include an allocation period indicating a period in which the multicast resource is allocated, and a lifetime in which allocation of the multicast resource is maintained.

The MAP IE excluding the transmission indication may not change unless the lifetime expires.

The method may further include transmitting a next MAP IE including new allocation information on the multicast resource to the multicast group when the lifetime expires.

According to yet another embodiment of the present invention, a method of managing a multicast resource is provided by a mobile station. The method includes receiving from a base station a MAP IE including information of the multicast resource and a transmission indication for indicating whether the multicast resource is fragmented, and identifying whether the multicast resource is fragmented by using the transmission indication.

When the multicast traffic is fragmented, the transmission indication may indicate which of fragmented traffics is transmitted by the multicast resource.

A first value of the transmission indication may indicate that no fragmented traffic is transmitted, a second value of the transmission indication may indicate that the first fragmented traffic is transmitted from among fragmented traffics, a third value of the transmission indication may indicate that the second to second last fragmented traffic are transmitted from among the fragmented traffics, and a fourth value of the transmission indication may indicate that the last fragmented traffic is transmitted from among the fragmented traffics.

The MAP IE may further include an allocation period indicating a period in which the multicast resource is allocated, and a lifetime in which allocation of the multicast resource is maintained.

The MAP IE excluding the transmission indication may not change unless the lifetime expires.

The method may further include receiving a next MAP IE including new allocation information on the multicast resource when the lifetime expires.

According to yet another embodiment of the present invention, an apparatus for managing a multicast resource is provided. The apparatus includes a resource manager configured to allocate multicast resource to a multicast group and to generate a MAP IE including information of the multicast resource and a transmission indication for indicating whether the multicast resource is fragmented, and a transmitter configured to transmit the MAP IE to the multicast group.

A first value of the transmission indication may indicate that no fragmented traffic is transmitted, a second value of the transmission indication may indicate that the first fragmented traffic is transmitted from among fragmented traffics, a third value of the transmission indication may indicate that the second to second last fragmented traffic are transmitted from among the fragmented traffics, and a fourth value of the transmission indication may indicate that the last fragmented traffic is transmitted from among the fragmented traffics.

The MAP IE may further include an allocation period indicating a period in which the multicast resource is allocated, and a lifetime in which allocation of the multicast resource is maintained.

The MAP IE excluding the transmission indication may not change unless the lifetime expires.

According to yet another embodiment of the present invention, an apparatus for managing a multicast resource is provided. The apparatus includes a receiver configured to receive from a base station a MAP IE including information of the multicast resource and a transmission indication for indicating whether the multicast resource is fragmented, and a controller configured to identify whether the multicast resource is fragmented by using the transmission indication.

A first value of the transmission indication may indicate that no fragmented traffic is transmitted, a second value of the transmission indication may indicate that the first fragmented traffic is transmitted from among fragmented traffics, a third value of the transmission indication may indicate that the second to second last fragmented traffic are transmitted from among the fragmented traffics, and a fourth value of the transmission indication may indicate that the last fragmented traffic is transmitted from among the fragmented traffics.

The MAP IE may further include an allocation period indicating a period in which the multicast resource is allocated, and a lifetime in which allocation of the multicast resource is maintained.

The MAP IE excluding the transmission indication may not change unless the lifetime expires.

### BRIEF DESCRIPTION OF THE DRAWINGS

FIG. 1 to FIG. 3 show a multicast communication system according to embodiments of the present invention.

FIG. 4 shows a multicast connection establishment method according to an embodiment of the present invention.

FIG. 5 is a flowchart of a multicast resource management method according to an embodiment of the present invention.

FIG. 6 shows an example of a multicast resource management method according to an embodiment of the present invention.

FIG. 7 and FIG. 8 are a block diagram of a multicast resource management apparatus according to embodiments of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “mobile station (MS)” may designate a terminal, a mobile terminal (MT), an advanced mobile station (AMS), a high reliability mobile station (HR-MS), a subscriber station (SS), a portable subscriber station (PSS), an access terminal (AT), a user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, a relay station (RS) performing base station function, a relay node (RN) performing base station function, an advanced relay station (ARS) performing base station function, a high reliability relay station (HR-RS) performing the base station function, a small cell BS (femto BS, home node B (HNB), pico BS, metro BS, micro BS, and so on), and so on, or may include all or some functions thereof.

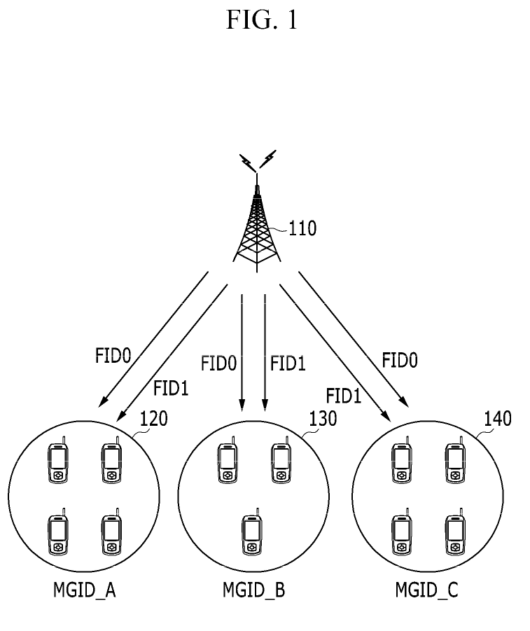

FIG. 1 shows a multicast communication system according to an embodiment of the present invention.

Referring to FIG. 1, a base station 110 uses a multicast group identifier (ID) allocated to a multicast group 120, to provide the multicast group 120 including a plurality of mobile stations with a multicast communication. The multicast group ID is uniquely allocated within the base station 110 and has a finite size. The multicast group ID is used as an ID for notifying the multicast group of the allocated resource. Other multicast groups 120, 130, and 140 have different multicast group ID MGID_A, MGID_B, and MGID_C.

The base station 110 uses a flow identifier (FID) for identifying a connection besides the multicast group ID. The base station 110 allocates the FID in each multicast group ID, thereby uniquely identifying the connection, i.e., a service flow within the multicast group. Since the FID is an ID for identifying a signal or traffic connection within the multicast group, a particular connection of the multicast group can be identified a combination of the multicast group ID and FID in the base station 110. That is, the base station 110 uses the multicast group ID and the FID to provide the multicast group 120 with a multicast service. The same FID (FID0 or FID1) may be used in the other multicast groups 120, 130, and 140.

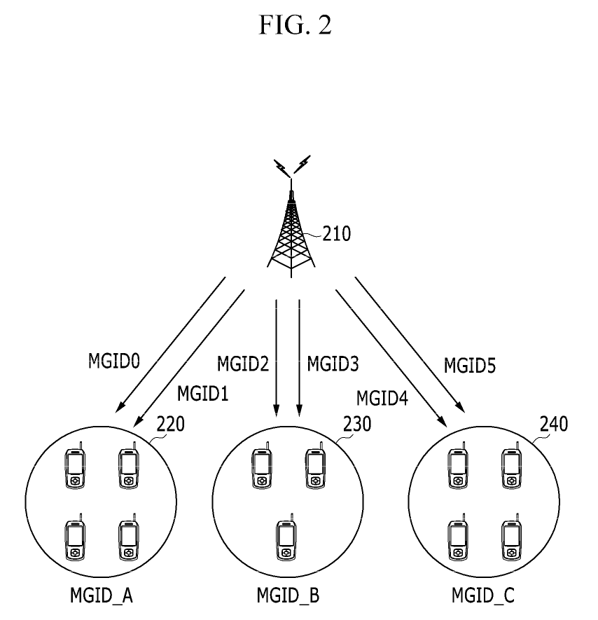

FIG. 2 shows a multicast communication system another embodiment of the present invention.

Referring to FIG. 2, a base station 210 uses a multicast group ID to provide a multicast group 220 including a plurality of mobile stations with the multicast service. The multicast group ID is uniquely allocated for identifying a connection, i.e., a service flow of the multicast group, and has a finite size. This multicast group ID may have a greater size than the multicast group ID described in FIG. 1, in order to identify the service flow as well as the multicast group. For example, the multicast group ID of FIG. 1 may have 12 bits, and the multicast group ID of FIG. 2 may have 16 bits.ID

Other multicast group IDs (MGID0, MGID1, MGID2, MGID3, MGID4, and MGID5) are used in different multicast groups 220, 230, and 240. A multicast resource allocated to the multicast service can be notified to the multicast group through the multicast group ID.

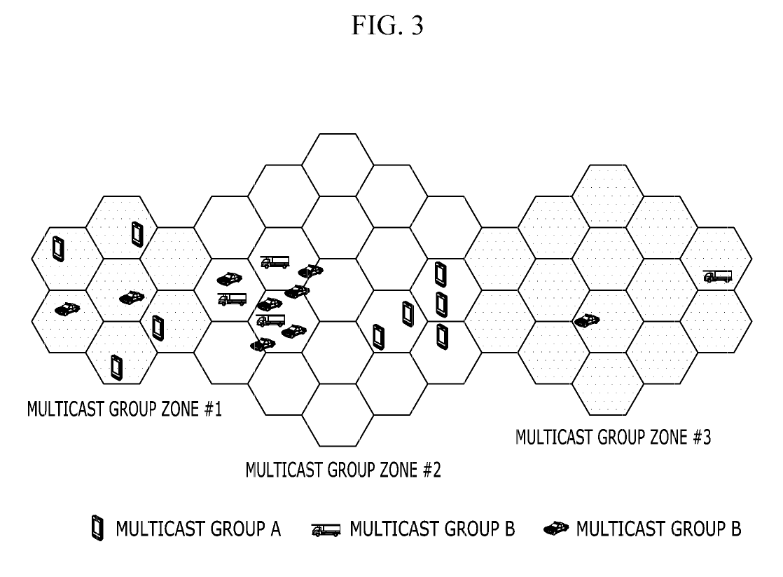

FIG. 3 shows a multicast communication system according to yet another embodiment of the present invention.

Referring to FIG. 3, a multicast group zone is defined as a base station set including at least one base station in a group communication system according to an embodiment of the present invention. A unique multicast group zone ID is allocated to the multicast group zone. A multicast group ID having a unique value is allocated to a multicast group within the multicast group zone, and a multicast service can be identified using an FID within the multicast group. That is, the multicast service that is provided within the multicast group zone can be identified using the multicast group ID and FID. Alternatively, a multicast group ID having a unique value is allocated to a multicast group within the multicast group zone, and a multicast service that is provided within the multicast group zone can be identified using the multicast group ID.

In the multicast group zone, a set of base stations uses the same multicast group ID and FID or the same multicast group ID for transmitting data of a certain service flow. Accordingly, if a mobile station has already registered with a base station for a multicast service, the mobile station can be seamlessly receive the multicast service without reregistering with other base station even if the mobile station moves to the other base station within the same multicast group zone. If the mobile station moves from a base station to another base station, those base stations provide the same multicast service but belong to different multicast group zone, the mobile station can seamlessly receive the multicast service by updating a parameter associated with the multicast service.

If only one base station belongs to a multicast group zone, the single base station uses a multicast group ID for providing a multicast service, independently from other base stations.

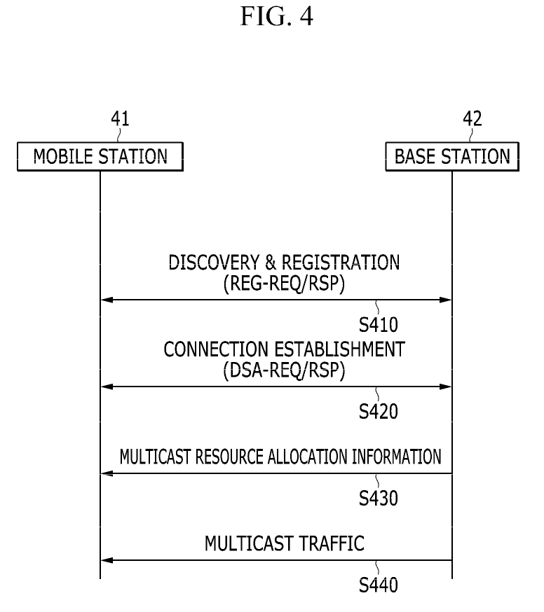

FIG. 4 shows a multicast connection establishment method according to an embodiment of the present invention.

Referring to FIG. 4, a mobile station 41 transmits a registration request (REG-REQ) message and a base station 42 transmits a registration response (REG-RSP) message to the mobile station 41 in response to the REG-REQ message (S410). To discover a multicast service, the mobile station 41 informs the base station 42 of support of multicast transmission by the REG-REQ message and the base station 42 registers the mobile station 41 by the REG-RSP message.

When the mobile station 41 registers to receive the multicast service, either the mobile station 41 or the base station 42 initiates a dynamic service addition (DSA) procedure for a multicast connection service (S420). The one node of the mobile station 41 and the base station 42 transmits a DSA-REQ message to the other node and receives a DSA-RSP message from the other node such that the multicast connection is established.

The DSA-REQ and DSA-RSP messages include a multicast parameter associated with the multicast service. The multicast parameter includes a multicast group ID of a multicast group to which a service flow is added. The multicast parameter may further include a FID associated with the multicast group ID.

Further, when a multicast group zone is supported, the multicast parameter may further include a multicast group zone ID where the service flow is valid. The mobile station 41 can add the service flow for starting a multicast service by the multicast parameter. Alternatively, the base station may periodically broadcast a multicast group zone ID through a broadcast message. If the multicast group zones are not locally overlapped with each other and are identified from each other (that is, a base station belongs to only one multicast group zone or the multicast group zone is not defined), the multicast parameter of the DSA-REQ or DSA-RSP message may not include multicast group zone ID.

The mobile station 41 and the base station 42 may not exchange a multicast service capability in the REQ-REQ/RSP exchange procedure (S410) but exchange the multicast service capability in the DSA-REQ/RSP exchange procedure (S420).

As such, after establishing the service flow, the mobile station 41 receives a downlink control channel including multicast resource allocation information from the base station 42 (S430), and receives multicast data from the base station 42 through the allocated resource (S440).

When a change of the service flow is required in the multicast service, the mobile station 41 and the base station 42 may perform a dynamic service change (DSC) procedure. That is, any one node of the mobile station 41 and the base station 42 transmits a DSC-REQ message, and the other node responds as a DSC-RSP message. In this case, the DSC-REQ message and the DSC-RSP message include a multicast parameter. The multicast parameter may include a current multicast group ID and a new multicast group ID, or current multicast group ID and FID and new multicast group ID and FID. The multicast parameter may further include a new multicast group zone ID.

When the multicast service is terminated, the mobile station 41 and the base station 42 may perform a dynamic service delete (DSD) procedure to delete the service flow. In this case, the multicast service of the multicast group may be terminated using the multicast group ID in the DSD procedure. The base station may terminate the multicast service using the multicast group zone ID in the DSD procedure. Any one node of the mobile station 41 and the base station 42 transmits a DSD-REQ message, and the other node responds as a DSD-RSP message.

As described above, according to an embodiment of the present invention, a mobile station and a base station can identify a supported multicast service through an exchange of a multicast service capability, and add, change or delete a service flow for the multicast service through a DSx (DSA, DSC, or DSD) procedure.

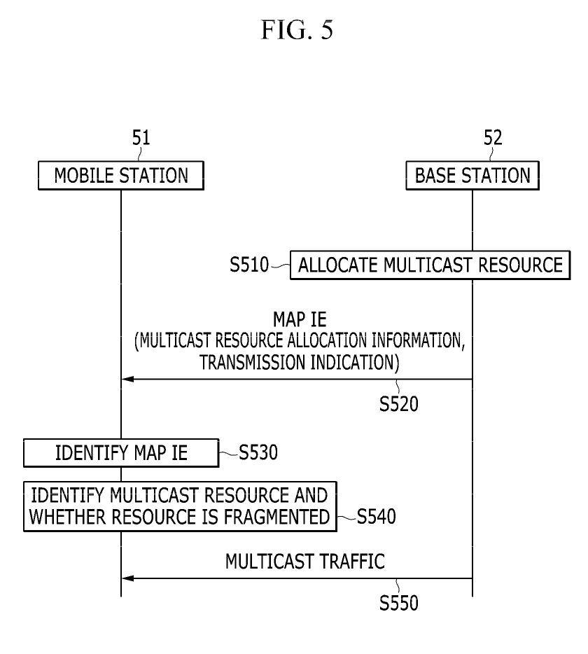

FIG. 5 is a flowchart of a multicast resource management method according to an embodiment of the present invention.

Referring to FIG. 5, a base station 52 persistently allocates a multicast resource to a multicast group for a multicast communication (S510), and transmits a downlink control channel including allocation information of multicast resource (S520). The downlink control channel may be a MAP information element (IE). For the multicast resource allocation, a new type of MAP IE may be defined. For example, the new type of MAP IE may be an HR-Multicast DL MAP IE (high reliability multicast downlink MAP IE) or an HR Multicast DL Assignment A-MAP IE that is a new type of A-MAP (advance MAP).

The base station 52 may fragment the multicast resource to use the limited multicast resource. That is, the base station 52 fragments the multicast resource, and transmits the multicast traffic through the fragmented multicast resources. In this case, the base station 52 includes a transmission indication (TI) to the downlink control channel, in order to indicate whether the multicast resource is fragmented (S520). The transmission indication can indicate that no fragmented traffic is transmitted or which of the fragmented traffics is transmitted, in accordance with its value.

A mobile station 51 identifies whether the received MAP IE is a MAP IE corresponding to the multicast group to which it belongs, based on the received MAP IE (S530). The mobile station 1 identifies the allocated multicast resource by the allocation information of multicast resource of the identified MAP IE, and identifies whether the fragmented traffic is transmitted through the allocated multicast resource or which of the fragmented traffics is transmitted when the fragmented traffic is transmitted (S540). Then, the mobile station 51 receives multicast traffic through the multicast resource (S550).

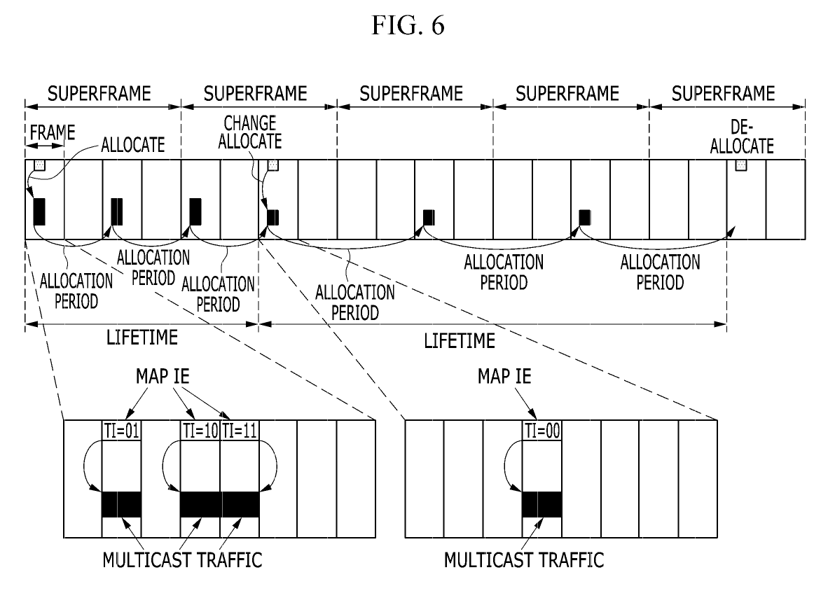

FIG. 6 shows an example of a multicast resource management method according to an embodiment of the present invention.

As shown in FIG. 6, the base station periodically (i.e., persistently) allocates the multicast resource at an interval of predetermined frames. The interval of predetermined frames corresponds to an allocation period. A plurality of frames, for example four frames may form one superframe, and one frame may include a plurality of subframes, for example eight subframes. In this case, the base station may transmit the MAP IE at a subframe to which the multicast resource is allocated.

The MAP IE includes multicast resource information allocated for the multicast communication, the allocation period, and a lifetime. The MAP IE further includes a transmission indication (TI). The lifetime indicates a period in which a persistent allocation is maintained, and the resource allocation information does not change until the lifetime expires. If the lifetime expires, the base station allocates a persistent resource for the multicast communication again or releases the previously allocated resource, and transmits the MAP IE including relevant information. The base station may transmit a next MAP IE at a frame whose frame number N_{frame} satisfies Equation 1, or may transmit the next MAP IE at a superframe whose superframe number N_{superframe} satisfies Equation 2.

N_{frame} modulo L+1==0 (1)

N_{superframe} modulo L+1==0 (2)

In Equations 1 and 2, L indicates the lifetime.

Accordingly, the mobile station can acquire information on the persistently allocated resource by only one decoding on the MAP IE such that a power loss that occurs when decoding the MAP IE can be reduced. Further, since the mobile station can know a period in which the MAP IE is transmitted or a period in which a multicast burst is transmitted in advance, the mobile station can efficiently perform a power saving when entering a power saving mode such as a sleep mode or an idle mode. Furthermore, the mobile station can know a time for decoding a new MAP IE by the lifetime included in the current MAP IE such that the mobile station can check a change of the persistently allocated resource.

In another embodiment, the base station may transmit a MAP IE including the same allocation information as previous allocation information before the lifetime expires. In this case, the base station may place a limit on a change or a release of the allocation information that it allows the change or release to be performed only when the lifetime expires. Accordingly, the base station can allow the mobile station to not unnecessarily receive and decode the resource information.

Table 1 shows an example of a transmission indication according to an embodiment of the present invention.

A base station can indicate whether additional traffic is transmitting before allocation period, by setting a value of the transmission indication as shown in Table 1.

When the multicast traffic is transmitted without being fragmented, the base station may set the value of the transmission indication to “00” to indicate that no additional transmission exists, that is, that no fragmented traffic is transmitted.

When the multicast traffic is fragmented into two fragmented traffics, the base station may set the value of the transmission indication of a downlink control channel corresponding to the first fragmented traffic to “01” and the value of the transmission indication of the downlink control channel corresponding to the second fragmented traffic to “10”. Accordingly, the base station can indicate that the multicast traffic has been fragmented and the downlink control channel corresponds to which of the fragmented traffics.

When the multicast traffic is fragmented into three or more fragmented traffics, the base station may set the value of the transmission indication of a downlink control channel corresponding to the first fragmented traffic to “01” and the value of the transmission indication of the downlink control channel corresponding to the last fragmented traffic to “11”. Further, the base station may set the value of the transmission indication of downlink control channels from the second to second last fragmented traffics to “10”. Accordingly, the base station can indicate that the multicast traffic has been fragmented and the downlink control channel corresponds to which of the fragmented traffics.

TABLE 1

| Value | Description |
|---|---|
| 0b00 | no (no additional transmission) |
| 0b01 | first (first transmission) |
| 0b10 | continue (more transmission) |
| 0b11 | last (no more transmission) |

The value of the transmission indication may change according to the fragmented condition of the multicast traffic each time the downlink control channel is transmitted. However, unless a lifetime expires, the downlink control channel excluding the value of the transmission indication does not change. If the lifetime expires, the downlink control channel may change or release the allocation.

An example of FIG. 6 shows that the multicast resource is persistently allocated with the allocation period of 2 and the lifetime of 6, the multicast resource is persistently allocated with the allocation period of 4 and the lifetime of 12, and then the allocated resource is released.

Further, the example of FIG. 6 shows that the multicast traffic is fragmented into three fragmented traffics when the allocation period is 2 and the lifetime is 6. The transmission indication TI of the MAP IE for the first fragmented traffic has a value of “01”, the transmission indication TI of the MAP IE for the second fragmented traffic has a value of “10”, and the transmission indication TI of the MAP IE for the last fragmented traffic has a value of “11”.

Furthermore, the example of FIG. 6 shows that the multicast traffic is not fragmented when the allocation period is 4 and the lifetime is 12. In this case, the transmission indication TI of the MAP IE has a value of “00”.

As such, according to an embodiment of the present invention, when the multicast traffic is fragmented by the limited resource, information about whether the multicast traffic is fragmented and information about which of the fragmented traffics is transmitted can be exactly provided to the mobile station together with the resource allocation information. Therefore, the limited resource can be efficiently used when the reliable multicast service is provided.

Next, various examples of a downlink control channel according to an embodiment of the present invention are described with reference to Table 2 to Table 6.

A MAP IE, for example an HR-Multicast DL MAP IE includes multicast resource information and subburst IE, and the subburst IE includes an allocation period, a lifetime, and a transmission indication. The subburst IE may be an HR_Multicast_DL_Subburst_IE.

The multicast resource information may be a predefined region ID (Region ID) or OFDMA symbol information and subchannel information. The OFDMA symbol information may include an OFDMA symbol offset and the number of OFDMA symbols, and the subchannel information may include a subchannel offset and the number of subchannels.

The HR-Multicast DL MAP IE may include an extended-2 DIUC (downlink interval usage code) and an extended-3 DIUC for indicating that the MAP IE is the HR-Multicast DL MAP IE, and may include a length of the MAP IE.

The subburst IE may further include a persistent flag, an allocation flag, allocation region information, or MCS (modulation coding scheme) level information. The persistent flag indicates whether the allocation is a persistent allocation, and the allocation flag indicates allocation of a resource or de-allocation of the resource. The allocation region information indicates an allocation region within a region allocated by the MAP IE, and may include a slot offset and slot duration. The MCS level information may be provided by the DIUC. The subburst IE may further include information on the multicast connection, for example a multicast group CID. The mobile station can identify the MAP corresponding to the multicast group to which it belongs by the multicast group CID.

The HR-Multicast DL MAP IE and the HR_Multicast_DL_Subburst_IE that are examples of the MAP IE and the subburst IE may be defined as in Table 2 and Table 3.

TABLE 2

| | Size | |
|---|---|---|
| Syntax | (bit) | Notes |
| HR-Multicast DL MAP IE { | | |
| Extended-2 DIUC | 4 | HR Multicast DL Map IE( ) = 0xF |
| | | (Extended-3 DIUC) |
| Length | 8 | Length in bytes |
| Extended-3 DIUC | 4 | 0x01 |
| Region ID Indicator | 1 | 0: not use Region_ID |
| | | 1: use Region_ID |
| If (Region_ID use indicator == 0) | | |
| { | | |
| OFDMA symbol offset | 8 | Offset from the start of DL subframe |
| Subchannel offset | 7 | |
| Number of OFDMA symbols | 7 | |
| Number of subchannels | 7 | |
| Rectangular subburst | 1 | Indicates subburst allocations are |
| Indication | | time-first rectangular. The duration field |
| | | in each subburst IE specifies the |
| | | number of subchannels for each |
| | | rectangular allocation. This is only valid |
| | | for AMC allocations and all allocations |
| | | with dedicated pilots. When this field is |
| | | clear, subbursts shall be allocated in |
| | | frequency-first manner and the duration |
| | | field reverts to the default operation. |
| Reserved | 2 | |
| } else | | |
| Region_ID | 8 | Index to the DL region defined in DL |
| | | region definition TLV in DCD |
| } | | |
| HR_Multicast_DL_Subburst_IE( ) | variable | Table 3 |
| Padding | variable | Padding to byte for the unspecified |
| | | portion of this IE (i.e. not including the |
| | | first two fields, “Extended-2 DIUC” and |
| | | “Length”); shall be set to 0. |
| } | | |

TABLE 3

| | Size | |
|---|---|---|
| Syntax | (bit) | Notes |
| HR_Multicast_DL_Subburst_IE( ) | | |
| { | | |
| N subburst | 4 | Number of subbursts in the 2D |
| | | rectangular region is this field value plus |
| | | 1. |
| Resource shifting indicator | 1 | 0 = No Resource shifting |
| | | 1 = Resource shifting |
| For(j=0;j<Number of | | |
| subbursts;j++){ | | |
| Allocation Flag | 1 | 1 = allocate |
| | | 0 = de-allocate |
| Group Indicator | 1 | TDD mode: Reserved, set to 0. |
| | | Used for FDD/H-FDD case only; to |
| | | indicate the group assignment of the MS |
| | | (see 8.4.4.2 and 8.4.4.2.1) |
| | | 0b0: Group #1 |
| | | 0b1: Group #2 |
| If (Allocation Flag == 0) { | | // deallocate |
| HR Multicast CID | 16 | |
| If (Resource shifting | | |
| indicator == 1) { | | |
| Duration | variable | Duration in slots. OFDMA Frame |
| | | duration dependent |
| | | 7 bits - 2.5 ms frame |
| | | 8 bits - 5 ms frame |
| | | 9 bits - 10 ms frame |
| | | 10 bits - 20 ms frame |
| Slot Offset | variable | Indicates the start of this persistent |
| | | allocation in |
| | | OFDMA slots, with respect to the lowest |
| | | numbered |
| | | OFDM symbol and the lowest numbered |
| | | subchannel in the region. |
| | | OFDMA Frame duration dependent |
| | | 7 bits - 2.5 ms frame |
| | | 8 bits - 5 ms frame |
| | | 9 bits - 10 ms frame |
| | | 10 bits - 20 ms frame |
| } | | |
| } else if (Allocation Flag == 1) | | // allocate |
| { | | |
| HR Multicast CID | 16 | |
| Persistent Flag | 1 | 0 = Non-persistent |
| | | 1 = Persistent |
| if( Power boost per subburst == | | |
| 1 ){ | | |
| Boosting | 1 | 0b000: Normal (not boosted) |
| | | 0b001: +6 dB |
| | | 0b010: −6 dB |
| | | 0b011: +9 dB |
| | | 0b100: +3 dB |
| | | 0b101: −3 dB |
| | | 0b110: −9 dB |
| | | 0b111: −12 dB; |
| | | Note that if the Persistent flag is set, the |
| | | boosting value applies to each instance |
| | | of the persistent allocation |
| } | | |
| Duration | variable | Duration in slots. OFDMA Frame |
| | | duration dependent |
| | | 7 bits - 2.5 ms frame |
| | | 8 bits - 5 ms frame |
| | | 9 bits - 10 ms frame |
| | | 10 bits - 20 ms frame |
| Slot Offset | variable | Indicates the start of this persistent |
| | | allocation in |
| | | OFDMA slots, with respect to the lowest |
| | | numbered |
| | | OFDM symbol and the lowest numbered |
| | | subchannel in the region. |
| | | OFDMA Frame duration dependent |
| | | 7 bits - 2.5 ms frame |
| | | 8 bits - 5 ms frame |
| | | 9 bits - 10 ms frame |
| | | 10 bits - 20 ms frame |
| If (Persistent Flag == 1) { | | |
| Allocation Period (ap) | 5 | Period of the persistent allocation is this |
| | | field |
| | | value plus 1 (unit is frame) |
| Lifetime(L) | 4 | Indicates the time to transmit the |
| | | information of this allocation and the |
| | | information except Transmission |
| | | Indication (TI) does not change until |
| | | lifetime expires. The next transmission of |
| | | information is at the frame whose frame |
| | | number, N_{frame}, satisfies the following |
| | | condition. |
| | | N_{frame} modulo L + 1 = 0 |
| } else | | |
| Next allocation offset | 5 | 5LSBs of frame number and it indicates |
| | | next allocation of the allocation of this |
| | | field |
| } | | |
| DIUC | 4 | |
| Repetition Coding Indication | 2 | 0b00: No Repetition coding |
| | | 0b01: Repetition coding of 2 used |
| | | 0b10: Repetition coding of 4 used |
| | | 0b11: Repetition coding of 6 used |
| Transmission Indication (TI) | 2 | Indicates whether additional traffic is |
| | | transmitting before allocation period |
| | | 0b00: no (no additional transmission) |
| | | 0b01: first (first transmission) |
| | | 0b10: continue (more transmission) |
| | | 0b11: last (no more transmission) |
| } | | |
| } | | |
| Padding | variable | Padding to nibble; shall be set to 0. |
| } | | |

The base station may add the above subburst IE (HR_Multicast_DL_Subburst_IE) to a hybrid automatic repeat request (HARQ) downlink MAP (HARQ DL MAP) for an HARQ resource allocation or a Persistent HARQ DL MAP for an HARQ persistent resource allocation, and use them for the multicast communication. For example, the HARQ DL MAP IE and the Persistent HARQ DL MAP IE may be defined as in Table 4 and Table 5.

TABLE 4

| | Size | |
|---|---|---|
| Syntax | (bit) | Notes |
| Persistent_HARQ_DL_MAP_IE( ) | | |
| { | | |
| Extended-2 DIUC | 4 | Persistent_HARQ_DL_MAP_IE = 0xD |
| Length | 8 | Length in bytes |
| RCID_Type | 2 | 0b00: Normal CID |
| | | 0b01: RCID11 |
| | | 0b10: RCID7 |
| | | 0b11: RCID3 |
| | | For HR Multicast, RCID_Type is set to |
| | | 0b00 and Normal CID is replaced by HR |
| | | Multicast CID |
| ACK Region Index | 1 | The index of the ACK region associated |
| | | with all subbursts (except HR multicast |
| | | DL burst) defined in this Persistent |
| | | HARQ DL MAP (FDD/H-FDD only) |
| while (data_remains){ | | |
| Region ID use indicator | 1 | 0: Region ID not used |
| | | 1: Region ID used |
| Change Indicator | 1 | 0: No change occurred |
| | | 1: Change occurred |
| if (Region ID use indicator == | | |
| 0){ | | |
| OFDMA Symbol offset | 8 | |
| Subchannel offset | 7 | |
| Number of OFDMA symbols | 7 | |
| Number of subchannels | 7 | |
| Rectangular subburst | 1 | Indicates subburst allocations are |
| indication | | time-first rectangular. The duration field |
| | | in each subburst IE specifies the number |
| | | of subchannels for each rectangular |
| | | allocation. The slot offset field in each |
| | | subburst IE specifies the subchannel |
| | | offset from the first subchannel for each |
| | | rectangular allocation. When this field is |
| | | clear, subbursts shall be allocated in |
| | | frequency-first manner and the duration |
| | | field reverts to the default operation |
| } | | |
| else{ | | |
| Region ID | 8 | Index to the DL region defined in DL |
| | | region definition |
| | | TLV in DCD |
| } | | |
| Power boost per subburst | 1 | Set to 1 to signal power boost per |
| | | subburst. This field |
| | | shall be set to 0 if Rectangular subburst |
| | | indication is set |
| | | to 0 |
| if (Power boost per subburst == | | |
| 0){ | | |
| Boosting | 3 | 0b000: Normal (not boosted) |
| | | 0b001: +6 dB |
| | | 0b010: −6 dB |
| | | 0b011: +9 dB |
| | | 0b100: +3 dB |
| | | 0b101: −3 dB |
| | | 0b110: −9 dB |
| | | 0b111: −12 dB |
| | | Note that if the Persistent flag is set, the |
| | | boosting value |
| | | applies to each allocation instance of the |
| | | persistent |
| | | allocation |
| } | | |
| Mode | 4 | Indicates the mode in this HARQ region |
| | | 0b0000: Persistent DL Chase HARQ |
| | | 0b0001: Persistent DL Incremental |
| | | redundancy HARQ |
| | | for CTC |
| | | 0b0010: Persistent DL Incremental |
| | | redundancy HARQ |
| | | for Convolutional Code |
| | | 0b0011: Persistent MIMO DL Chase |
| | | HARQ |
| | | 0b0100: Persistent MIMO DL IR HARQ |
| | | 0b0101: Persistent MIMO DL IR HARQ |
| | | for Convolutional |
| | | Code |
| | | 0b0110: Persistent MIMO DL STC |
| | | HARQ |
| | | 0b0111: HR Multicast DL subburst |
| | | 0b1000 to 0b1111: Reserved |
| Subburst IE Length | 8 | Length, in nibbles, to indicate the size of |
| | | the subburst IE |
| | | in this HARQ mode. The MS may skip |
| | | DL HARQ |
| | | Subburst IE if it does not support the |
| | | HARQ mode. |
| | | However, the MS shall decode NACK |
| | | Channel field |
| | | from each DL HARQ Subburst IE to |
| | | determine the UL |
| | | ACK channel it shall use for its DL |
| | | HARQ burst |
| if( Mode == 0b0000){ | | |
| Persistent DL Chase HARQ | variable | |
| subburst IE | | |
| } elseif (Mode == 0b0001){ | | |
| Persistent DL Incremental | variable | |
| redundancy HARQ for CTC | | |
| subburst IE | | |
| } elseif (Mode == 0b0010){ | | |
| Persistent DL Incremental | variable | |
| redundancy HARQ for | | |
| Convolutional Code | | |
| } elseif (Mode == 0b0011){ | | |
| Persistent MIMO DL Chase | variable | |
| HARQ | | |
| } elseif (Mode == 0b0100){ | | |
| Persistent MIMO DL IR | variable | |
| HARQ | | |
| } elseif (Mode == 0b0101){ | | |
| Persistent MIMO DL IR | variable | |
| HARQ for Convolutional | | |
| Code | | |
| } elseif (Mode == 0b0110){ | | |
| Persistent MIMO DL STC | variable | |
| HARQ | | |
| } elseif (Mode == 0b0111){ | | |
| HR Multicast DL subburst IE | variable | Table 3 |
| } | | |
| } | | |
| Padding | variable | Padding to byte for the unspecified |
| | | portion of this IE |
| | | (i.e., not including the first two fields, |
| | | “Extended-2 |
| | | DIUC” and “Length”); shall be set to 0. |
| } | | |

TABLE 5

| | Size | |
|---|---|---|
| Syntax | (bit) | Notes |
| HARQ_DL_MAP_IE( ) { | | |
| Extended-2 DIUC | 4 | HARQ_DL_MAP_IE( ) = 0x7 |
| Length | 8 | Length in bytes |
| RCID_Type | 2 | 0b00: Normal CID |
| | | 0b01: RCID11 |
| | | 0b10: RCID7 |
| | | 0b11: RCID3 |
| | | For HR Multicast, RCID_Type |
| | | is set to 0b00 and Normal CID |
| | | is replaced by HR Multicast |
| | | CID |
| ACK region index | 1 | The index of the ACK region |
| | | associated with all subbursts |
| | | (except HR multicast DL burst) |
| | | defined in this HARQ DL map |
| | | IE (FDD/H-FDD only). |
| | | 0: first ACK region |
| | | 1: second ACK region |
| | | This bit shall be set to 0 for |
| | | TDD mode. |
| Reserved | 1 | |
| While (data remains) { | | |
| Boosting | 3 | 0b000: Normal (not boosted) |
| | | 0b001: +6 dB |
| | | 0b010: −6 dB |
| | | 0b011: +9 dB |
| | | 0b100: +3 dB |
| | | 0b101: −3 dB |
| | | 0b110: −9 dB |
| | | 0b111: −12 dB; |
| Region_ID use indicator | 1 bit | 0: not use Region_ID |
| | | 1: use Region_ID |
| If (Region_ID use indicator == 0 ) { | | |
| OFDMA symbol offset | 8 | Offset from the start symbol of |
| | | DL subframe |
| Subchannel offset | 7 | |
| Number of OFDMA symbols | 7 | |
| Number of subchannels | 7 | |
| Rectangular subburst Indication | 1 | Indicates subburst allocations |
| | | are time-first rectangular. The |
| | | duration field in each subburst |
| | | IE specifies the number of |
| | | subchannels for each |
| | | rectangular allocation. This is |
| | | only valid for AMC allocations |
| | | and all allocations with |
| | | dedicated pilots. When this |
| | | field is clear, subbursts shall |
| | | be allocated in frequency-first |
| | | manner and the duration field |
| | | reverts to the default |
| | | operation. |
| Reserved | 2 | |
| } else { | | |
| Region_ID | 8 | Index to the DL region defined |
| | | in DL region definition TLV in |
| | | DCD |
| } | | |
| Mode | 4 | Indicates the mode of this |
| | | HARQ region: |
| | | 0b0000: Chase HARQ |
| | | 0b0001: Incremental |
| | | redundancy HARQ for CTC |
| | | 0b0010: Incremental |
| | | redundancy HARQ for |
| | | Convolutional Code 0b0011: |
| | | MIMO Chase HARQ |
| | | 0b0100: MIMO IR HARQ |
| | | 0b0101: MIMO IR HARQ for |
| | | Convolutional Code |
| | | 0b0110: MIMO STC HARQ |
| | | 0b0111: HR Multicast DL |
| | | subburst |
| | | 0b1000-0b1111: Reserved |
| Subburst IE Length | 8 | Length, in nibbles, to indicate |
| | | the size of the sub-burst IE in |
| | | this HARQ mode. The MS may |
| | | skip DL HARQ Subburst IE if it |
| | | does not support the HARQ |
| | | mode. However, the MS shall |
| | | decode N ACK Channel field |
| | | from each DL HARQ Subburst |
| | | IE to determine the UL ACK |
| | | channel it shall use for its DL |
| | | HARQ burst. |
| If (Mode == 0b0000) { | | |
| DL_HARQ_Chase_subburst_IE( ) | variable | |
| } else if (Mode == 0b0001) { | | |
| DL_HARQ_IR_CTC_subburst_IE( ) | variable | |
| } else if (Mode == 0b0010) { | | |
| DL_HARQ_IR_CC_subburst_IE( ) | variable | |
| } else if (Mode == 0b0011) { | | |
| MIMO_DL_Chase_HARQ_subburst_IE( ) | variable | |
| } else if (Mode == 0b0100) { | | |
| MIMO_DL_IR_HARQ_subburst_IE ( ) | variable | |
| } else if (Mode == 0b0101) { | | |
| MIMO_DL_IR_HARQ_for_CC_{—subburst}_IE( ) | variable | |
| } else if (Mode == 0b0110) { | | |
| MIMO_DL_STC_HARQ_subburst_IE( ) | variable | |
| } elseif (Mode == 0b0111){ | | |
| HR Multicast DL subburst IE | variable | Table 3 |
| } | | |
| } | | |
| Padding | variable | Padding to byte for the |
| | | unspecified portion of this IE, |
| | | i.e., not including the first two |
| | | fields, “Extended-2 DIUC” and |
| | | “Length”; shall be set to 0 |
| } | | |

Since fields that are not described in Table 2 to Table 5 are defined in, for example, IEEE Std 802.16-2012, descriptions for the fields are omitted.

Next, multicast resource allocation information according to another embodiment of the present invention will be described with reference to Table 6.

A base station may generate a multicast allocation A-MAP IE for allocating a multicast resource using an A-MAP, and the multicast allocation A-MAP IE may be for example an HR-Multicast DL Assignment A-MAP IE.

The multicast allocation A-MAP IE includes an allocation period, a lifetime, a transmission indication, and multicast allocation information as described above. The multicast allocation information may include a resource index indicating a location and a size of the multicast resource. The multicast allocation information may further include information (Isizeoffset) used to compute a burst size index and an indicator (long TTI indicator) indicating the number of subframes spanned by the allocated resource.

The multicast allocation A-MAP IE may inform whether the A-MAP IE is allocation of a resource or de-allocation of the resource by a value of the allocation period, without using a flag for indicating the allocation or the de-allocation. For example, when the allocation period has a value of “00”, the A-MAP IE may indicate the de-allocation.

The base station may generate 16-bit cyclic redundancy check (CRC) based on the randomized sequence of information bits of the multicast allocation A-MAP IE. Further, the base station may mask the 16-bit CRC by a CRC mask including a multicast group ID, and attach the masked CRC to the multicast allocation A-MAP IE. The terminal can identify the multicast allocation A-MAP IE using the CRC mask including the multicast group ID to which it belongs. That is, the mobile station can identify the multicast allocation A-MAP IE corresponding to the multicast group to which it belongs using the CRC mask.

The HR-Multicast DL Assignment A-MAP IE that is an example of the multicast allocation A-MAP IE may be defined as in Table 6.

TABLE 6

| | Size | |
|---|---|---|
| Field | (bits) | Value/Description |
| HR-Multicast_DL_Assignment_A-MAP_IE( ) | | |
| { | | |
| A-MAP IE Type | 4 | HR-Multicast DL Assignment A-MAP |
| | | IE |
| Allocation period | 2 | Period of persistent allocation of |
| | | multicast resource. |
| | | If (Allocation Period == 0b00), it |
| | | indicates the deallocation of |
| | | persistent resource. |
| | | 0b00: deallocation |
| | | 0b01: 2 frames |
| | | 0b10: 4 frames |
| | | 0b11: 6 frames |
| If (Allocation Period == 0b00) { | | |
| Resource Index | 11 | 5 MHz: 0 in first 2 MSB bits + 9 bits |
| | | for resource index |
| | | 10 MHz: 11 bits for resource index |
| | | 20 MHz: 11 bits for resource index |
| | | Resource index includes location and |
| | | allocation size. |
| Long TTI Indicator | 1 | Indicates number for AAI subframes |
| | | spanned by the allocated resource. |
| | | 0b0: 1 AAI subframe (default TTI) |
| | | 0b1: 4 DL AAI subframe for FDD or |
| | | all DL AAI subframes for TDD (long |
| | | TTI) |
| Reserved | 22 | |
| } else if(Allocation Period != | | |
| 0b00) { | | |
| Isizeoffset | 5 | Offset used to compute burst size |
| | | index |
| MEF | 2 | MIMO encoder format |
| | | 0b00: SFBC |
| | | 0b01: Vertical encoding |
| | | 0b10: Multi-layer encoding |
| | | 0b11: CDR |
| If (MEF ==0b01) { | | Parameter for vertical encoding |
| Mₜ | 3 | Number of streams in transmission |
| | | Mₜ <= Nₜ |
| | | Nₜ: Number of transmit antennas at |
| | | the HR-BS |
| | | 0b000: 1 stream |
| | | 0b001: 2streams |
| | | 0b010: 3streams |
| | | 0b011: 4streams |
| | | 0b100: 5streams |
| | | 0b101: 6streams |
| | | 0b110: 7streams |
| | | 0b111: 8streams |
| Reserved | 1 | |
| } else if (MEF == 0b10) { | | Parameters for multi-layer encoding |
| Si | 4 | Index to identify the combination of |
| | | the number of streams and the |
| | | allocated pilot stream index in a |
| | | transmission with MU-MIMO, and the |
| | | modulation constellation of paired |
| | | user in the case of 2 stream |
| | | transmission |
| | | 0b0000: 2 streams with PSI = stream1 |
| | | and other modulation = QPSK |
| | | 0b0001: 2 streams with PSI = stream1 |
| | | and other modulation = 16QAM |
| | | 0b0010: 2 streams with PSI = stream1 |
| | | and other modulation = 64QAM |
| | | 0b0011: 2 streams with PSI = stream1 |
| | | and other modulation information not |
| | | available |
| | | 0b0100: 2 streams with PSI = stream2 |
| | | and other modulation = QPSK |
| | | 0b0101: 2 streams with PSI = stream2 |
| | | and other modulation = 16QAM |
| | | 0b0110: 2 streams with PSI = stream2 |
| | | and other modulation = 64QAM |
| | | 0b0111: 2 streams with PSI = stream2 |
| | | and other modulation information not |
| | | available |
| | | 0b1000: 3 streams with PSI = stream1 |
| | | 0b1001: 3 streams with PSI = stream2 |
| | | 0b1010: 3 streams with PSI = stream3 |
| | | 0b1011: 4 streams with PSI = stream1 |
| | | 0b1100: 4 streams with PSI = stream2 |
| | | 0b1101: 4 streams with PSI = stream3 |
| | | 0b1110: 4 streams with PSI = stream4 |
| | | 0b1111: n/a |
| } | | |
| Resource Index | 11 | 5 MHz: 0 in first 2 MSB bits + 9 bits |
| | | for resource index |
| | | 10 MHz: 11 bits for resource index |
| | | 20 MHz: 11 bits for resource index |
| | | Resource index includes location and |
| | | allocation size. |
| Long TTI Indicator | 1 | Indicates number for AAI subframes |
| | | spanned by the allocated resource. |
| | | 0b0: 1 AAI subframe (default TTI) |
| | | 0b1: 4 DL AAI subframe for FDD or |
| | | all DL AAI subframes for TDD (long |
| | | TTI) |
| Lifetime(L) | 4 | Indicates the time to transmit next |
| | | HR-Multicast DL Assignment A-MAP |
| | | and the information excluding |
| | | Transmission Indication (TI) of this |
| | | HR-Multicast DL Assignment A-MAP |
| | | does not change during the allocation |
| | | duration. |
| | | The next HR-Multicast DL |
| | | Assignment A-MAP is at the |
| | | superframe whose superframe |
| | | number, N_{superframe}, satisfies the |
| | | following condition. |
| | | N_{superframe} modulo L + 1 = 0 |
| Transmission Indication (TI) | 2 | Indicates whether additional traffic is |
| | | transmitting before allocation period |
| | | 0b00: no (no additional transmission) |
| | | 0b01: first (first transmission) |
| | | 0b10: continue (more transmission) |
| | | 0b11: last (no more transmission) |
| Reserved | 5 | |
| } | | |
| } | | |

Since fields that are not described in Table 6 are defined in, for example, IEEE Std 802.16.1-2012, descriptions for the fields are omitted.

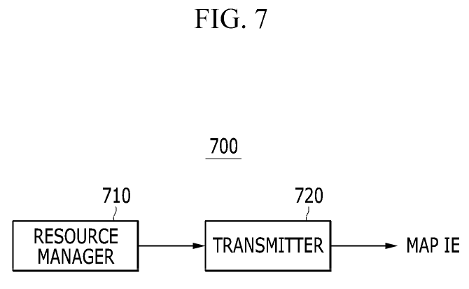

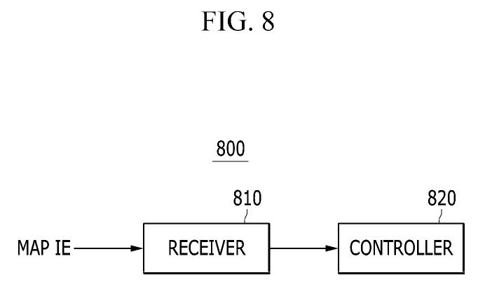

Next, a multicast resource management apparatus for performing a multicast resource management apparatus according to an embodiment of the present invention is described with reference to FIG. 7 and FIG. 8.

FIG. 7 is a block diagram of a multicast resource management apparatus according to an embodiment of the present invention.

Referring to FIG. 7, a multicast resource management apparatus 700 includes a resource manager 710 and a transmitter 720.

The resource manager 710 allocates a multicast resource to a multicast group, and generates a MAP IE including allocation information of the multicast resource, an allocation period, a lifetime, and a transmission indication. The transmitter 720 transmits the MAP IE to the multicast group.

The multicast resource management apparatus 700 may be included in a base station or may be the base station itself.

FIG. 8 is a block diagram of a multicast resource management apparatus according to another embodiment of the present invention.

Referring to FIG. 8, a multicast resource management apparatus 800 includes a receiver 810 and a controller 820.

The receiver 810 receives a MAP IE from a base station. The MAP IE includes allocation information of the multicast resource allocated to a multicast group, an allocation period, a lifetime, and a transmission indication. The controller 820 identifies whether the received MAP IE corresponds to the multicast group to which it belongs, by a multicast group IE or a CRC mask. The controller 820 identifies whether the multicast resource is fragmented by using the identified MAP IE.

The multicast resource management apparatus 800 may be included in a mobile station or may be the mobile station itself.

At least some functions of a multicast resource management method or apparatus according to an embodiment of the present invention may be embodied by hardware or software combined with the hardware. For example, a processor that is embodied by a central processing unit (CPU), a chipset, or a microprocessor, etc. may perform a function of a resource manager 710 or a controller 820, and a transceiver may perform a function of a transmitter 720 or a receiver 810.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of managing a multicast resource by a base station, the method comprising:
allocating a multicast resource to a multicast group;
generating a MAP information element (MAP IE) including information of the multicast resource and a transmission indication for indicating whether the multicast resource is fragmented; and
transmitting the MAP IE to the multicast group.

2. The method of claim 1, wherein, when the multicast traffic is fragmented, the transmission indication indicates which of fragmented traffics is transmitted by the multicast resource.

3. The method of claim 1, wherein a first value of the transmission indication indicates that no fragmented traffic is transmitted,
a second value of the transmission indication indicates that the first fragmented traffic is transmitted from among fragmented traffics,
a third value of the transmission indication indicates that the second to second last fragmented traffic are transmitted from among the fragmented traffics, and
a fourth value of the transmission indication indicates that the last fragmented traffic is transmitted from among the fragmented traffics.

4. The method of claim 1, wherein the MAP IE further includes an allocation period indicating a period in which the multicast resource is allocated, and a lifetime in which allocation of the multicast resource is maintained.

5. The method of claim 4, wherein the MAP IE excluding the transmission indication does not change unless the lifetime expires.

6. The method of claim 4, further comprising transmitting a next MAP IE including new allocation information on the multicast resource to the multicast group when the lifetime expires.

7. A method of managing a multicast resource by a mobile station, the method comprising:
receiving from a base station a MAP information element (MAP IE) including information of the multicast resource and a transmission indication for indicating whether the multicast resource is fragmented; and
identifying whether the multicast resource is fragmented by using the transmission indication.

8. The method of claim 7, wherein, when the multicast traffic is fragmented, the transmission indication indicates which of fragmented traffics is transmitted by the multicast resource.

9. The method of claim 7, wherein a first value of the transmission indication indicates that no fragmented traffic is transmitted,
a second value of the transmission indication indicates that the first fragmented traffic is transmitted from among fragmented traffics,
a third value of the transmission indication indicates that the second to second last fragmented traffic are transmitted from among the fragmented traffics, and
a fourth value of the transmission indication indicates that the last fragmented traffic is transmitted from among the fragmented traffics.

10. The method of claim 7, wherein the MAP IE further includes an allocation period indicating a period in which the multicast resource is allocated, and a lifetime in which allocation of the multicast resource is maintained.

11. The method of claim 10, wherein the MAP IE excluding the transmission indication does not change unless the lifetime expires.

12. The method of claim 10, further comprising receiving a next MAP IE including new allocation information on the multicast resource when the lifetime expires.

13. An apparatus for managing a multicast resource, the apparatus comprising:
a resource manager configured to allocate multicast resource to a multicast group, and to generate a MAP information element (MAP IE) including information of the multicast resource and a transmission indication for indicating whether the multicast resource is fragmented; and
a transmitter configured to transmit the MAP IE to the multicast group.

14. The apparatus of claim 13, wherein a first value of the transmission indication indicates that no fragmented traffic is transmitted,
a second value of the transmission indication indicates that the first fragmented traffic is transmitted from among fragmented traffics,
a third value of the transmission indication indicates that the second to second last fragmented traffic are transmitted from among the fragmented traffics, and
a fourth value of the transmission indication indicates that the last fragmented traffic is transmitted from among the fragmented traffics.

15. The apparatus of claim 13, wherein the MAP IE further includes an allocation period indicating a period in which the multicast resource is allocated, and a lifetime in which allocation of the multicast resource is maintained.

16. The apparatus of claim 15, wherein the MAP IE excluding the transmission indication does not change unless the lifetime expires.

17. An apparatus for managing a multicast resource, the apparatus comprising:
a receiver configured to receive from a base station a MAP information element (MAP IE) including information of the multicast resource and a transmission indication for indicating whether the multicast resource is fragmented; and
a controller configured to identify whether the multicast resource is fragmented by using the transmission indication.

18. The apparatus of claim 17, wherein a first value of the transmission indication indicates that no fragmented traffic is transmitted,
a second value of the transmission indication indicates that the first fragmented traffic is transmitted from among fragmented traffics,
a third value of the transmission indication indicates that the second to second last fragmented traffic are transmitted from among the fragmented traffics, and
a fourth value of the transmission indication indicates that the last fragmented traffic is transmitted from among the fragmented traffics.

19. The apparatus of claim 17, wherein the MAP IE further includes an allocation period indicating a period in which the multicast resource is allocated, and a lifetime in which allocation of the multicast resource is maintained.

20. The apparatus of claim 19, wherein the MAP IE excluding the transmission indication does not change unless the lifetime expires.
